(19) United States
(12) Patent Application Publication
(10) Pub. No.: US 2012/0260427 A1
(43) Pub. Date: Oct. 18, 2012

(54) Newborn Circumcision Board

(76) Inventor: Toan Lam, Salt Lake City, UT (US)

(21) Appl. No.: 13/086,177

(22) Filed: Apr. 13, 2011

(51) Int. Cl. A61G 13/00

(52) U.S. Cl. 5/603

(57) ABSTRACT

A circumcision board may include a generally rectangular board of a hard but lightweight plastic with a memory foam pad covered with disposable plastic sheet. The board may feature a drainage hole to facilitate draining of fluids that may be released during the procedure (i.e., blood or urine). Disposable restraint straps may be secured to the sides of the board to hold the infant down firmly but comfortably. The board may also feature a raising top portion for the child's comfort and for ease of positioning the child and possible prevention of aspiration. The upper half of the board could be adjusted by use of a quick-release mechanism. The entire board may lay completely flat when the top portion is not raised, and may be suitable for storage or for easy transport.

### FIELD

This application relates generally to devices for use in a circumcision procedure. More particularly, this application relates to a comfortable adjustable board and restraint to hold an infant in place during a circumcision procedure.

### BACKGROUND

Circumcision of newborn male infants continues to be practiced by medical professionals worldwide. Current estimates are that one-sixth to one-third of males born in the world have been circumcised, including almost 75% of boys presently born in the United States. With such a continuing prevalence of the procedure in evidence, it is imperative that practitioners of the procedure have access to medical devices that ensure a safe and comfortable experience for both the practitioner and the patient.

Circumcisions were traditionally performed on any flat surface. In time, practitioners realized the benefits of a sterile surface on which to work, and further improvements that ensured the safety and comfort of the patient were developed. Many attempts to incorporate these and other improvements into one device have been made and marketed in the last several years. For example, various operating tables and pillows have been marketed, but these suffer from a lack of specialization for the nuances of circumcision procedures, like a drainage area or restraints that are designed specifically for holding an infant in the correct position to most effectively receive a circumcision. Information relevant to other attempts to address these issues and problems can be found in U.S. Pat. Nos. 2,700,381; 2,743,974; 2,751,268; 2,846,700; 2,867,483; 2,995,407; 3,650,523; 4,790,041; 5,160,185; 5,329,934; and 6,023,802.

However, each one of these references suffers from one or more of the following disadvantages: lack of portability due to bulk or the usage of heavier materials, inadequate drainage areas and channels or slopes that lead to those areas, inability to lay flat for storage, lack of inclusion of disposable cloth straps; lack of utilization of the benefits of modern “memory foam” for comfort, and lack of quick release mechanisms for additional convenience. Thus, a need exists for a device that overcomes the disadvantages of the prior art.

### SUMMARY

This application describes and discloses an apparatus that satisfies the above-mentioned needs. The apparatus may include a generally rectangular board of a hard but lightweight plastic covered in memory foam or a suitable substitute and then covered with a germ, bacteria, virus, and cleaning chemical-resistant plastic sheet which may be removable and disposable. The board may also feature a drainage hole in a lower portion of the board that corresponds to where the infant's penis would be located when the child is on the board. The hole may be located in the center of a depressed area in a lower portion of board to facilitate draining of fluids that may be released during the procedure (i.e., blood or urine). Disposable restraint straps may be secured to the sides of the board by Velcro strips to hold the infant down firmly but comfortably.

The board may also feature a raising top portion for the child's comfort and for ease of positioning the child. The top portion may be lifted off the base of the support board by an adjustable support bar or other release mechanism. The upper half of the board could be adjusted by use of a quick-release mechanism which is located in the middle of the board at the meeting place of the lower and top halves of the board. The entire board may lay completely flat when the top portion is not raised, and may be suitable for storage or for easy transport, especially given the light weight of the device.

These and other aspects of the present invention will become more fully apparent from the following description and appended claims.

### BRIEF DESCRIPTION OF THE DRAWINGS

The following description can be better understood in light of Figures, in which:

FIG. 1 is a top view of an exemplary circumcision board;

FIG. 2 is an oblique view of an exemplary circumcision board;

FIG. 3 is a side view of an exemplary circumcision board; and

FIG. 4 is an oblique view of an exemplary circumcision board.

Together with the following description, the Figures demonstrate and explain the principles of an infant circumcision board and associated components and methods. In the Figures, the thickness and configuration of components may be exaggerated for clarity. The same reference numerals in different Figures represent the same component.

### DETAILED DESCRIPTION

In the illustrated embodiments, aspects and features of exemplary infant circumcision boards systems and associated components and methods are disclosed and described below.

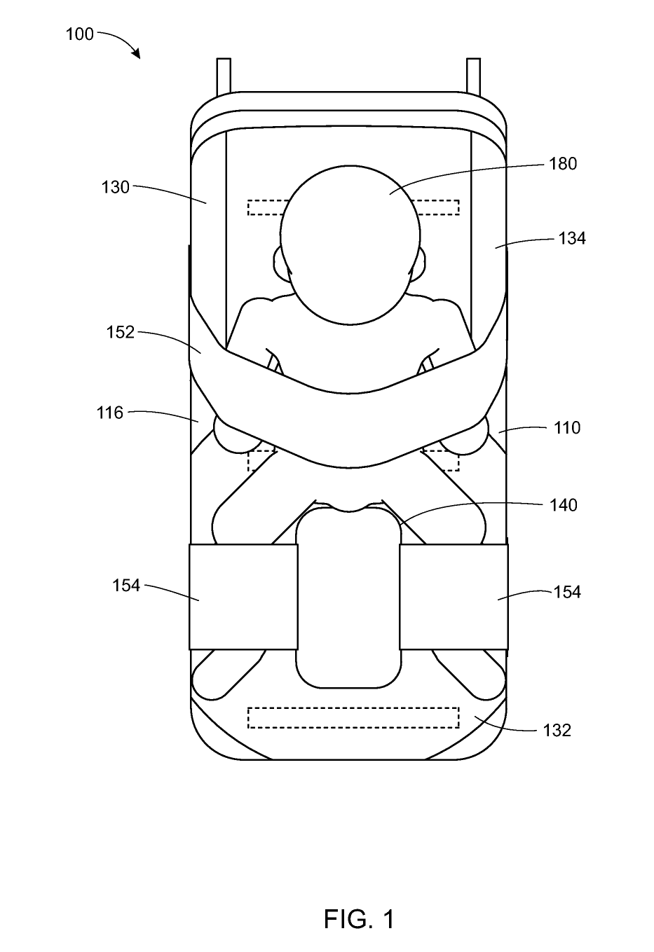

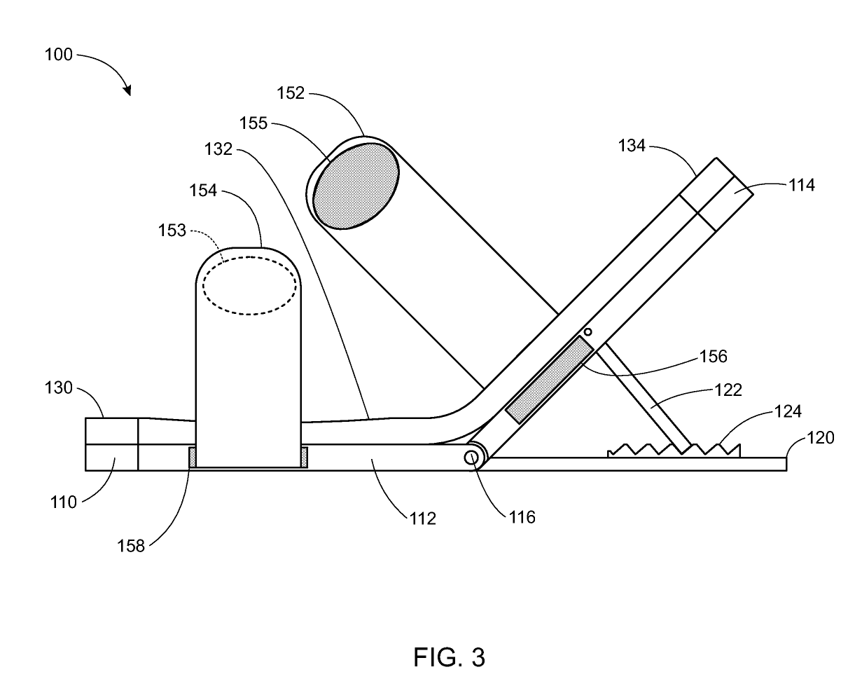

FIGS. 1-3 are illustrative of an embodiment of circumcision board 100. Circumcision board 100 may include support board 110, surface supports 120, pad 130, fluid drain opening 140 in support board 110, restraining straps 152, 154, and support 122. Circumcision board 100 may be sized to accommodate an infant during a circumcision procedure performed on young male infants up to about 20 pounds.

Support board 110 may include lower portion 112 and upper portion 114. Support board 110 may be formed of a lightweight plastic material such as HDPE, polycarbonate, or metal such as aluminum, stainless steel, or other suitable material. Support board 110 (along with surface support 120) may be formed with sufficient strength to support an infant up to about 20 pounds and some additional pressure from a doctor performing a circumcision or a parent comforting an infant placed on support board 110. Support board 110 may be generally rectangular, with each of lower portion 112 and upper portion 114 being generally square or rectangular in shape.

Upper portion 114 and lower portion 112 may be connected together such that the pivot about joint 116 in a hinged relationship. The hinged relationship between upper portion 114 and lower portion 112 may allow upper portion 114 to be raised to provide a comfortable reclined position for an infant placed on circumcision board 100, and to provide easy access for a doctor to the penis of the infant during a circumcision procedure. The reclined position may reduce the amount of fluids (such as urine and blood) that might contact the infant when laying flat during the procedure The reclined position may also reduce vomiting which can lead to aspiration.

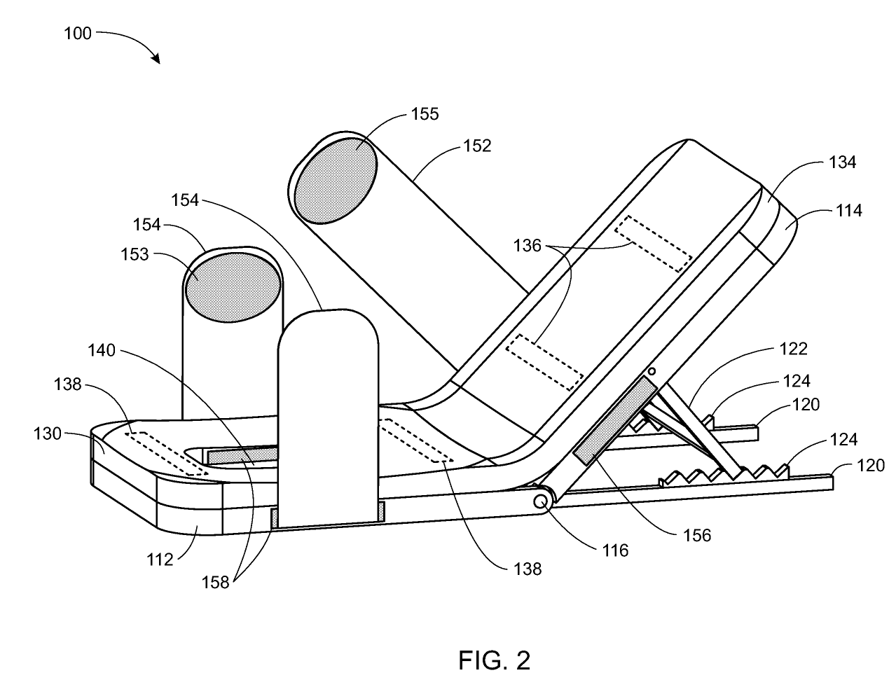

Lower portion 112 may include fluid drain opening 140 formed generally in the center of lower portion 112. Lower portion 112 may also be formed such that fluids spilled or otherwise placed on lower portion 112 would tend to flow to drain opening 140. For example, lower portion 112 may slope from the periphery of lower portion 112 toward drain opening 140, as shown in FIG. 2. Similarly, in other embodiments, channels may be formed in lower portion 112, in lower pad 132 of pad 130, or in both to encourage fluid flow to drain opening 140.

Surface support 120 may be provided for stability when support board is in a reclined position. Surface support 120 may be one or more legs extending from lower portion 112 as shown in FIG. 2, or surface support 120 may be a single extension having the approximate shape and/or dimensions of upper portion 114. Surface support 120 may extend under and connect to lower portion 112. Similarly, surface support 120 may be integrally formed into lower portion 112.

Upper portion 114 may be selectively placed and held in different positions between 0 degrees (flat and coplanar with lower portion 112) and 90 degrees (sitting completely upright), depending on the preference of the doctor. In most instances, a reclined position between about 15 and 45 degrees may be preferable. In some embodiments, one or more reclined positions may be provided by an adjustment mechanism to be selected. For example, in FIG. 2, support 122 may be attached to upper portion 114 and positioned against stops 124 on surface supports 120 to achieve a reclined position. In the illustrated embodiment, four recline positions and the flat position are selectable depending on which stop 124 support 122 is engaged. Thus, for the illustrated embodiment of FIGS. 1-3, five total positions, including four recline positions and a lay-flat position are selectable. Other embodiments may use any number of adjustment mechanisms used to provide adjustable recline positions for support board 110. In the lay-flat position, the circumcision board 100 may be easily stored and transported, making it ideal for use by a mohel or a pediatrician who travels to different hospitals or offices to perform circumcisions. Circumcision board 100 may also be easily shipped in the lay-flat position by stacking multiple boards and saving space.

Support 122 may be a pair of legs with a cross-brace as shown in the embodiment of FIGS. 1-3, or it may be a U-shaped element, a planar element, or any suitable shape and configuration for supporting upper portion 114 in a reclined position. For example, support 122 may be pivotably coupled to upper portion 114 and may be fixed with a detent mechanism or other mechanism into a number of inclined positions, such that surface support 120 is not needed in addition to support 122. Similarly, support 122 may be attached to surface support 120 and configured to engage different points on the bottom side of upper portion 114 to select different reclined positions.

Pad 130 may be provided for comfort and support of an infant placed on circumcision board 100. Pad 130 may include interior material formed of memory foam or other suitable cushioning or comfort material. The interior material may be covered with a suitable covering similar to a hospital bed as is known in the industry to keep the interior material clean and functioning properly and to allow for thorough cleaning as is required in a medical environment. Similarly, the interior material and/or covering may also be made of or include antiseptic agents to prevent bacteria, fungus, germs, or viruses from growing in the interior material. In some embodiments, a removable, disposable plastic sheet may be used to cover pad 130 during each different procedure to help persevere cleanliness and sterility. The plastic sheet may be chemical resistant to cleaning, antiseptic and other chemicals that may be used in conjunction with cleaning circumcision board 100 or during a circumcision procedure.

Pad 130 may be formed to conform to the shape and adjustability of support board 110. For example, lower pad 132 of pad 130 may be formed with a slope from the periphery to drain hole 140, similar to lower portion 112 of support board 110. In some embodiments, lower pad 132 of pad 130 may be separate from upper pad 134. Pad 130 may be releasably attached to support board 110 with attachments 136, 138.

Attachments 136, 138 may be hook and loop fabric fasteners, or any other suitable fasteners. Similarly, attachments 136, 138 may be along a periphery of pad 130, or positioned in any place suitable for holding pad 130 to support board 110. In some embodiments, pad 130 may be formed with pockets for inserting a part of lower portion 112 and/or upper portion 114 to secure pad 130 to support board 110. In such embodiments, strap connections 156, 158 (discussed in detail below) may be incorporated into pad 130.

Restraint straps 152, 154 may be used to comfortably restrain an infant laying on support board 110 during a circumcision procedure. Restraint straps 152, 154 may be used to hold the infant relatively still to lessen any chance of unnecessary injury. Restraint straps 152, 154 may be formed of fabric or other soft material and may be somewhat pliable to allow for some movement by the infant when restrained. For example, restraint straps 152, 154, may be formed of an elastomeric material similar to material used on some comfort-fitting diapers for adhesive tabs. Restraint straps 152, 154 may be disposable with each use to ensure a sterile work environment for the doctor and infants.

Restraint straps 152, 154 may be releasably attached to support board 110 or otherwise to another portion of circumcision board 100. As illustrated, restraint straps 152, 154 may be releasably attached to support board 110 using hook and loop fasteners (such as Velcro®), with strap connections 156, 158 being attachable to strap fasteners 153, 155. Strap connections 156, 158 may be located on the side edges of each of lower portion 112 and upper portion 114 of support board 110. Strap connections 156, 158 may be located on opposing edges to provide restraint straps 152, 154 with attachment points on both sides of support table 110.

Restraint straps 154 may be provided to restrain each leg of an infant on circumcision board 100, attached across strap connections 158 located on the inside of drain opening 140 and on the outside of lower portion 112. In other embodiments, a single restraint strap 154 may be used to restrain both legs. Similarly, restraint straps 152, 154 may include strap connections 153, 155 on each end to releasably attach at both ends to strap connections 156 and 158 on opposing sides of support table 110. In some embodiments, restraint straps 152, 154 may be formed of another material that can be cleaned and sterilized for multiple uses, similar to other restraint devices used in hospitals.

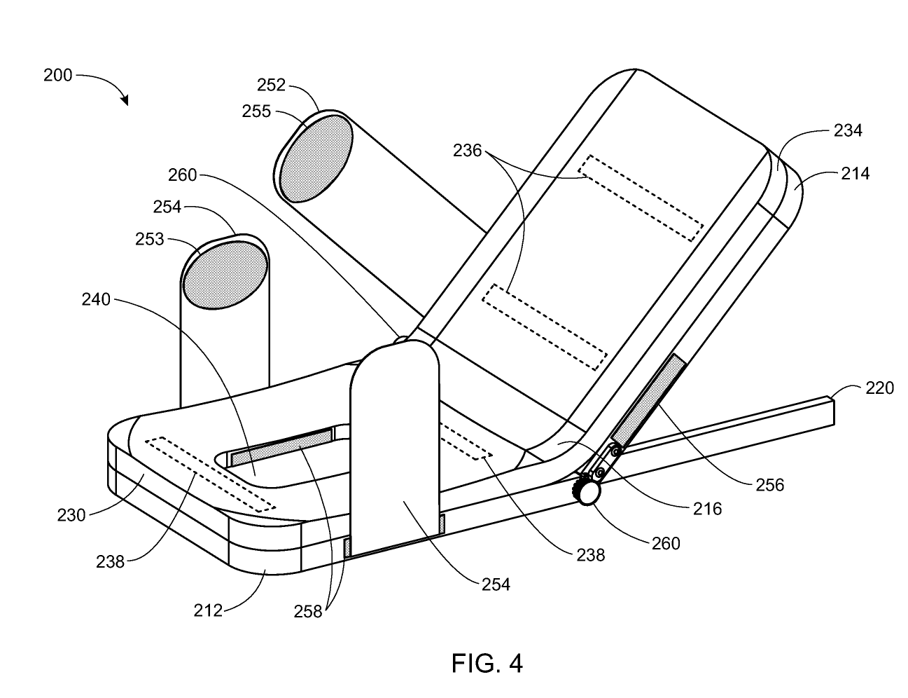

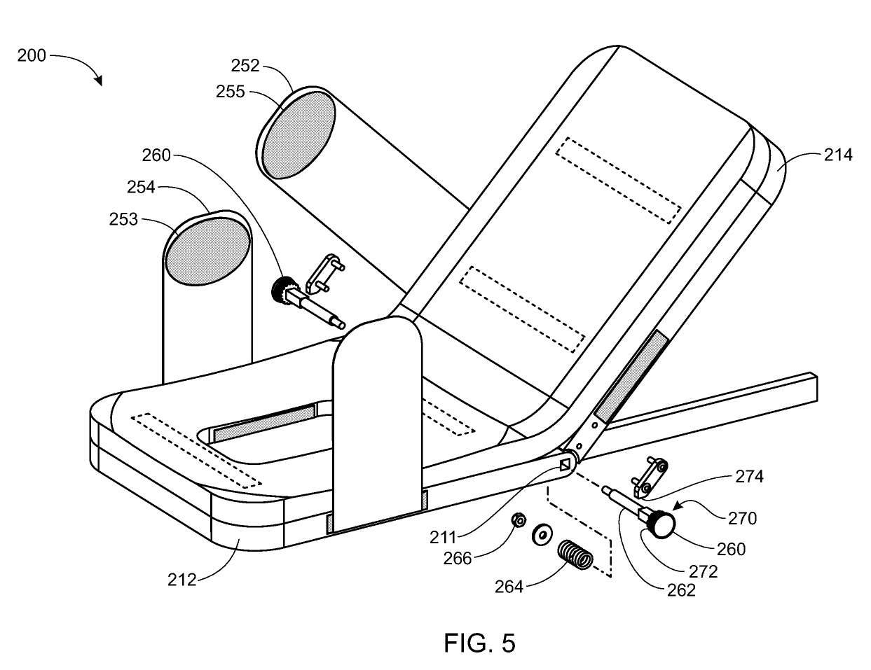

FIGS. 4 and 5 illustrate an embodiment of a circumcision table 200 with a quick-release adjustment mechanism for adjusting the reclining position of upper portion 214. Similar to circumcision board 100 described above in many respects, circumcision board 200 may include support board 210 with upper portion 214 and lower portion 212, surface supports 220, pad 230, fluid drain opening 240 in support board 210, and restraining straps 252, 254. Pad 230 may be releasably held to support board 210 with fasteners 236 and 238, and restraining straps 252, 254 may connect with support board 210 through connections 258, 256, 253, 255, similar to circumcision board 100 described above.

Quick-release mechanism 270 may include knob 260, shaft 262, spring 264, retaining washer 266, and locking tab 274, which may interact with rack 272 on knob 260. To activate quick-release mechanism 270 to adjust the recline position of upper portion 214, a user may pull knobs 260 outward, which releases tab 274 from rack 272 and allows upper portion 214 to pivot with respect to lower portion 212. Once upper portion 214 is in a desired position, knobs 260 may be released, allowing spring 262 to pull rack 272 against tab 274 to engage into a locked position or recline as desired. Shaft 262 may be at least partially square to pass through a square opening 211 in lower portion 212 to prevent shaft 262 from rotating.

While the above description contains various exemplary and other specific embodiments, these should not be construed as limitations on the scope, but merely as exemplary embodiments from among the many embodiments encompassed by the claims. Many other embodiments and variations are possible within the teaching of this document. Thus, the scope of the invention should be determined by the appended claims and their legal equivalents, and not solely by the examples and embodiments given.

What is claimed is:

1. A circumcision assist device, the device comprising:
a support board having a lower portion and an upper portion, the lower portion and the upper portion being hingedly coupled;
a fluid collection opening in the lower portion of the support board;
at least one restraint strap; and
at least one surface support extending from the lower portion.

2. The device of claim 1, wherein the upper portion is rotatable with respect to the lower portion between 0 and about 90 degrees.

3. The device of claim 2, wherein the lower portion and the upper portion are selectively adjustable to be held in one of at least three positions of rotation.

4. The device of claim 3, further comprising a support attached to the upper portion, and wherein the upper portion and lower portion are held in any one of the at least three positions of rotation with the support extending between the upper portion and the at least one surface support.

5. The device of claim 3, further comprising a rotation release mechanism, wherein the upper portion and lower portion are held in any one of the at least three positions of rotation by selective engagement of the rotation release mechanism.

6. The device of claim 5, wherein the rotation release mechanism includes a spring-biased release handle.

7. The device of claim 1, further comprising a pad removably attached to the support board, wherein the pad has an opening corresponding to the fluid collection opening in the support board.

8. The device of claim 7, wherein the pad is a memory foam center and a cover.

9. The device of claim 8, wherein the cover is germ, bacteria, virus, and cleaning chemical resistant.

10. The device of claim 1, wherein the at least one restraint strap is formed of cloth.

11. The device of claim 1, wherein the at least one restraint strap is configured to restrain an infant laying on the support board for a circumcision procedure.

12. The device of claim 1, wherein the at least one restraint strap is disposable, such that the at least one restraint strap is configured to be replaced after each procedure.

13. The device of claim 1, wherein at least one end of the at least one restraint strap is releasably attachable to the support board with at least one of: hook and loop fasteners, buckles, snaps, and buttons.

14. The device of claim 1, wherein the lower portion is generally rectangular in shape, and wherein a top surface of the lower portion is generally sloped from the exterior edges to the fluid collection opening.

15. The device of claim 14, further comprising a pad removably attached to the support board, and wherein at least a portion of the pad is formed to conform to the shape of the top surface of the lower portion.

16. The device of claim 1, wherein the support board is formed from a medical grade plastic.

17. The device of claim 1, wherein the at least one surface support is coplanar with the lower portion.

18. A circumcision assist device, the device comprising:
a support board having a lower portion and an upper portion, the lower portion and the upper portion being hingedly coupled;
a rotation release mechanism configured to selectively hold the upper portion and lower portion at a desired angle with respect to each other;
a fluid collection opening in the lower portion of the support board, wherein the lower portion is configured such that fluid on the lower portion flows to the fluid collection opening;
at least one restraint strap configured to restrain an infant laying on the support board for a circumcision procedure; and
at least one surface support extending from the lower portion.
